(19) United States
(12) Patent Application Publication
(10) Pub. No.: US 2001/0049293 A1
(43) Pub. Date: Dec. 6, 2001

(54) Information processing apparatus having display which can be conveniently seen even when the apparatus is folded

(75) Inventor: Mamoru Shimazaki, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/871,096

(22) Filed: May 31, 2001

(30) Foreign Application Priority Data
May 31, 2000 (JP) 161910/2000

(51) Int. Cl. H04M 1/00

(52) U.S. Cl. 455/550; 455/575; 455/90

(57) ABSTRACT

An information processing apparatus to which this invention is applicable comprises a hinge mechanism and first and second cases each of which has front and back sides, the first and the second cases are coupled to each other through the hinge mechanism so that the information processing apparatus is folded with the front sides of the first and the second cases are faced to each other. The first case has a display unit so that a displayed content of the display unit can be seen from both of the front and the back sides of the first case. The display unit is provided with a liquid crystal display plate having first and second sides and a pair of screens, the screens being substantially transparent and being arranged over the first and the second sides of the liquid crystal display plate. The second case has at least one of operating buttons for the operation of the information processing apparatus.

### BACKGROUND OF THE INVENTION

This invention relates to an information processing apparatus such as a portable cellular phone or a PHS (Personal Handy phone System) phone, and particularly relates to an information processing apparatus which can be folded.

Recently, a quantity of information to be displayed on a display of a radio terminal station represented by, for example, the portable cellular phone or the PHS phone, is increasing as the functions thereof become highly advanced. Therefore the efforts are made to develop the radio terminal station provided with the display which is larger than that of the conventional one. Furthermore, the radio terminal station is required to be compact in shape so that it is convenient for a user to carry the radio terminal station. In consideration of the above, various kinds of the portable radio terminal stations of folding portable type are proposed and are provided as merchandise. In addition, other information processing apparatuses such as a notebook-size personal computer or a palm-topped type personal computer are also generally structured as folding type because of the reason as mentioned.

As a conventional information processing apparatus such as the portable cellular phone of the type are disclosed in, for example, Japanese Patent Unexamined Publications (JP-A) Nos. 68896/1999, 30226/1999, and 195151/1994.

However, conventional information processing apparatuses as mentioned above have the matters disadvantageous in that the size is too large, the structure is too complex, the cost is too high, and so on.

### SUMMARY OF THE INVENTION

It is therefore an object of this invention to provide an information processing apparatus of folding type which is compact in shape and which has a display which can be seen even when the apparatus is folded.

The other objects, features, and advantages of this invention will become clear as the description proceeds.

This invention is directed to an information processing apparatus comprising a hinge mechanism and a first and a second case each of which has front and back sides. The first and the second cases are coupled to each other through the hinge mechanism so that the information processing apparatus is folded with the front sides of the first and the second cases are faced to each other. The first case has a display unit so that a displayed content of the display unit can be seen from both of the front and the back sides of the first case. The display unit is provided with a liquid crystal display plate having first and second sides and a pair of screens, the screens being substantially transparent and being arranged over the first and the second sides of the liquid crystal display plate. The second case has at least one of operating buttons for the operation of the information processing apparatus.

### BRIEF DESCRIPTION OF THE DRAWINGS

FIG. 1 is a perspective view showing a conventional portable cellular phone of folding type of a first proposal which is unfolded and which is seen from a back side;

FIG. 2 is a perspective view showing the conventional portable cellular phone of folding type of the first proposal which is folded;

FIG. 3 is a perspective view showing the other conventional portable cellular phone of folding type of a second proposal which is unfolded and which is seen from a handling (operating) side;

FIG. 4 is a perspective view showing the conventional portable cellular phone of folding type of the second proposal which is unfolded and which is seen from the counter side of the handling side;

FIG. 5 is a perspective view showing a conventional information processing apparatus of folding type of a fourth proposal which is unfolded and which is seen from a keyboard side;

FIG. 6 is a perspective view showing the conventional information processing apparatus of folding type of the fourth proposal which is unfolded and which is seen from a back side;

FIG. 7 is a side view of a display unit of the conventional information processing apparatus of folding type of the fourth proposal;

FIG. 8 is a perspective view showing the conventional information processing apparatus of folding type of the fourth proposal which is folded and in which the display unit is integrally arranged on a main body;

FIG. 9 is a perspective view showing a portable cellular phone as an information processing apparatus of folding type according to an embodiment of this invention in which the case is opened and which is seen from a front side;

FIG. 10 is a perspective view showing the portable cellular phone as the information processing apparatus of folding type according to the embodiment of this invention in which the case is opened and which is seen from a back side;

FIG. 11 is a perspective view showing the portable cellular phone of folding type according to the embodiment of this invention in which the case is closed;

FIG. 12 is a partial cross sectional view showing the portable cellular phone of folding type according to the embodiment of this invention in which the cases are opened from each other and in which only a display unit is cross-sectionally shown;

FIG. 13 is a partial cross sectional view showing the portable cellular phone of folding the according to the embodiment of this invention in which the case is closed and in which only the display unit is cross-sectionally shown; and

FIG. 14 is a flow chart illustrating control steps for a displayed content of two screens of the display unit by the portable cellular phone of folding type according to the embodiment of this invention.

### DESCRIPTION OF THE PREFERRED EMBODIMENTS

In order to facilitate an understanding of this invention, description will at first be made with reference to the drawings as regards conventional information processing apparatuses of a type described above.

FIG. 1 shows a first proposal, that is, a portable cellular phone as the information processing apparatus of folding type proposed in the past. Referring to FIG. 1, a portable cellular phone 100 is unfolded. The portable cellular phone 100 is viewed from a back side when a first and a second cases 101 and 102 are opened (unfolded) from each other. The first and the second cases 101 and 102 can be opened from each other as shown in FIG. 1 by rotating around a hinge portion 103. On the other hand, the first and the second cases 101 and 102 can be also closed (folded) to each other as shown by an arrow 104 in FIG. 1 by which the first case 101 rotates so as to relatively approach the second case 102. On a front side surface of the first case 101 not shown in FIG. 1, a display such as an LCD (a Liquid Crystal Display) and a speaker are arranged. On the other hand, on a front side surface of the second case 102 also not shown in FIG. 1, a control pad including various button-switches and a microphone are arranged. On a back side surface of the second case 102, a power supply unit 105 is arranged. Furthermore, at an upper side edge of the first case 101 in FIG. 1, an antenna 106 capable of expanding and contracting is arranged.

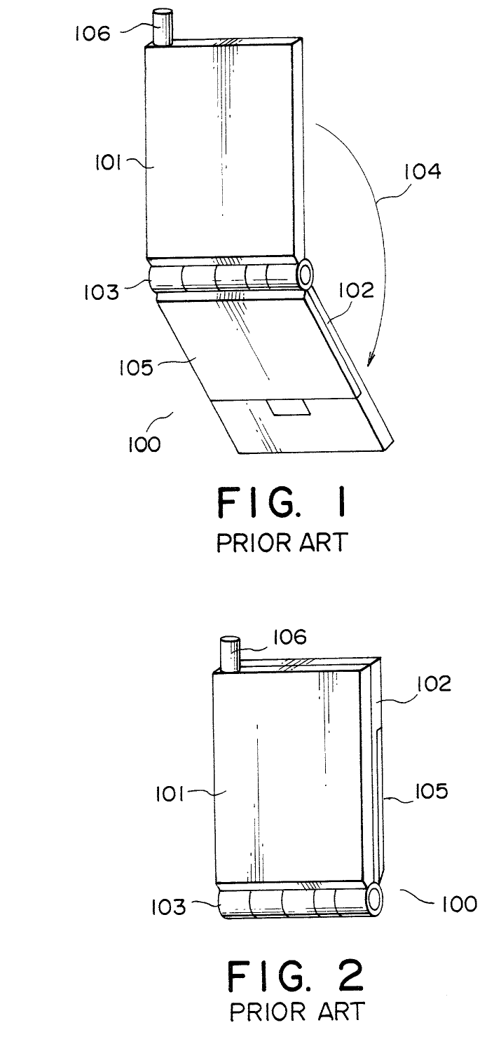

FIG. 2 shows the portable cellular phone 100 which is folded. The first and the second cases 101 and 102 are closed up to each other by rotating around the hinge portion 103. When the portable cellular phone 100 is folded as shown in FIG. 2, the display is completely hidden. Therefore, if the user only wants to see information displayed on the display, because the user cannot see it when the portable cellular phone 100 is folded as shown in FIG. 2, the portable cellular phone 100 must be unfolded as shown in FIG. 1. However, when the portable cellular phone 100 is unfolded, the portable cellular phone 100 takes much larger area than when the portable cellular phone 100 is folded. Furthermore, even if handling the portable cellular phone 100 by the use of the control pad is not necessary, the control pad is always exposed in order to see the display. Therefore, an expected handling error may happen when something touched on the control pad.

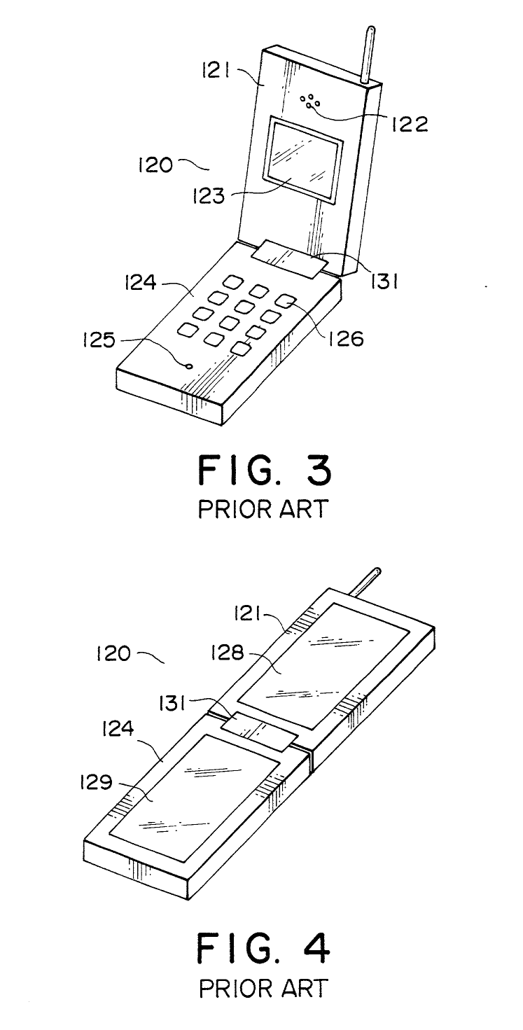

FIGS. 3 and 4 show a second proposal, that is, another portable cellular phone as the information processing apparatus of folding type proposed in the past. The second proposal is disclosed in Japanese Patent Unexamined Publication (A) No. 68896/1999. In FIG. 3, a portable cellular phone 120 is unfolded and viewed from an inner side surface as a handling side. In FIG. 4, the portable cellular phone 120 is completely unfolded and viewed from a back side surface. Referring to FIG. 3, a first case 121 is provided with a speaker 122 and a first display 123 arranged on an inner side surface. A second case 124 is provided with a microphone 125 and control buttons 126 arranged on an inner side surface. On the other hand, referring to FIG. 4, the first case 121 is provided with a second display 128 arranged on a back side surface. The second case 124 is provided with a third display 129 arranged on a back side surface. The first, the second, and the third displays 123, 128, and 129, respectively, are structured by, for example, the LCD. At least one of the first, the second, and the third displays 123, 128, and 129, respectively, is surely exposed and therefore the portable cellular phone 120 is always able to display even when the first and the second cases 121 and 124 are folded around a hinge mechanism 131 in various positions. However, the second proposal must need a plurality of displays (LCDs). Therefore, cost of the portable cellular phone 120 will be increased. Furthermore, size of the portable cellular phone 120 is uselessly enlarged in order to arrange the displays therein.

In order to settle such matter as regards the second proposal as mentioned above, a third proposal, that is, an information processing apparatus of folding type is proposed. The third proposal is disclosed in Japanese Patent Unexamined Publication (A) No. 30226/1999. In the third proposal, only a first case is provided with a display arranged on a first side surface. The first case is movably attached to a second case through a hinge mechanism. The first case can rotate around a longitudinal direction axis thereof at a turning scope of 180 degrees. Namely, both the first and a second side surfaces of the first case can be lined with a predetermined side surface of the second case. Consequently, the first and the second cases can be closed to each other with the display exposed on an external surface or hidden in an internal surface of the first and the second cases closed to each other. However, in the third proposal, because it is necessary for the hinge mechanism to provide two direction rotations at right angles to each other with electric connection between the first and the second case secured, the hinge mechanism has a complex structure and a high cost. Furthermore, as the structure of the hinge mechanism is complex, the hinge mechanism is enlarged in size. Therefore, the information processing apparatus is enlarged in size or the first or the second case must relatively be reduced in size to the hinge mechanism being enlarged.

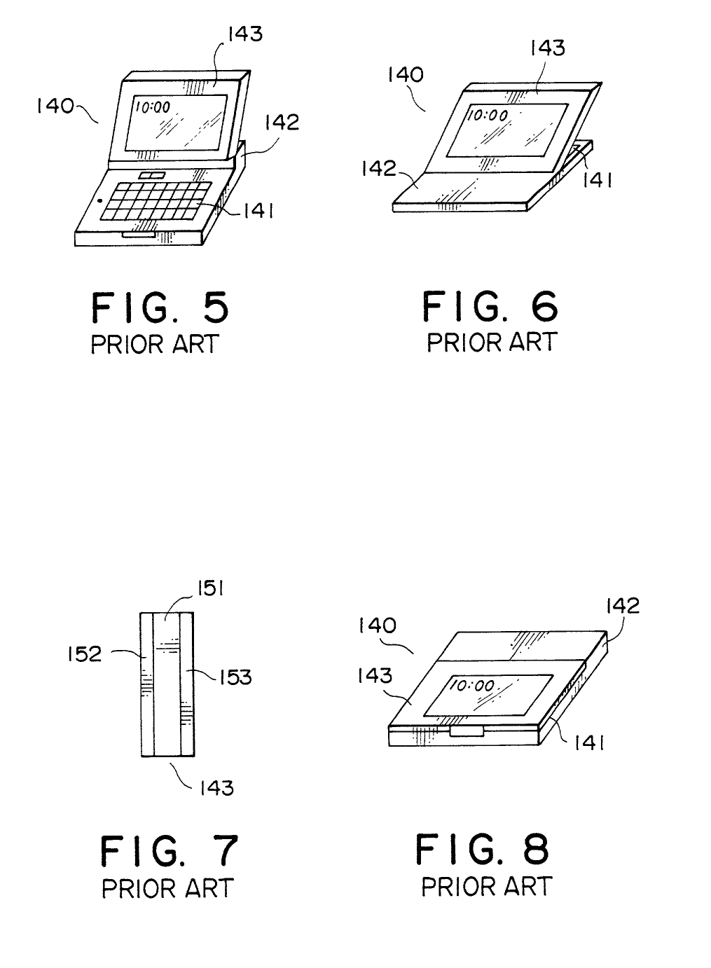

FIGS. 5 through 8 show a fourth proposal, that is, the other information processing apparatus of folding type. The fourth proposal is disclosed in Japanese Patent Unexamined Publication (A) No. 195151/1994. Referring to FIG. 5, an information processing apparatus 140 has a main body 142 provided with a keyboard 141 and a display unit 143. In FIG. 5, the display unit 143 is arranged at the rear end of the main body 142 so as to slant.

FIG. 6 is a back side view of the information processing apparatus 140 when the display unit 143 is moved from a position shown in FIG. 5. Namely, after once removing the display unit 143 from the main body 142 by the use of some means, the display unit 143 is changed relatively to the main body 142 from the position shown in FIG. 5 and arranged as shown in FIG. 6. As shown in FIG. 7, the display unit 143 has an LCD 153 of transparent type and screens 152 and 153 arranged over both side surfaces of the LCD 153 so as to hold the LCD 153. Consequently, the display unit 143 can be seen whichever the display unit 143 is positioned as shown in FIG. 6 or positioned as shown in FIG. 5. When the display unit 143 is positioned as shown in FIG. 6, the display unit 143 changes view (displayed content) thereof 180 degrees in left and right directions from that shown in FIG. 5. Thus, the information processing apparatus 140 can display as “10:00” as shown in FIG. 6 and the displayed content can be normally seen from the bask side of the information apparatus 140.

Referring to FIG. 8, the display unit 143 is retracted on the main body 142. The display unit 143 is arranged on the main body 142 so that the back side surface faces and is exposed upwardly. As same as the position shown in FIG. 6, the information processing apparatus 140 can display so that “10:00” is normally seen.

In the fourth proposal, the display unit 143 is attached to the approximate center region of the main body 142 so as to reversely slant to that shown in FIG. 6 after once removing the display unit 143 from the main body 142. However, it is unknown and unclear a structure of an attachment of the display unit 143, that is, how the display unit 143 is attached to the main body 142. These are took into consideration, it may be unnecessary that the display unit 143 has the screens 153 and 153. Namely, it is sufficient that the display unit 143 only has a screen arranged on one side thereof. In other words, it is in vain as regards design that the fourth proposal has two screens. It is further necessary a connector and an attachment (which are not shown) for the information processing apparatus 140. The connector is used for electrically connecting between the main body 142 and the display unit 143 so as to maintain that the main body 142 and the display unit 143 are removable from each other. The attachment is used for attaching the display unit 143 on the main body 142 so that the display unit 143 can be attached on the main body 142 in various positions and various locations. Namely, it is difficult to design so as to reduce in size the information processing apparatus 140 as shown in FIG. 8.

Furthermore, the information processing apparatus 140 can display as “10:00” so that “10:00” is always seen in normal direction by turning the content of the display unit 143 180 degrees in the left and right directions as shown in FIGS. 5 and 6. However, if “10:00” can be seen, from both of the front and the back sides of the information processing apparatus 140, in normal position at the upper left of the display unit 143, it is necessary for the information processing apparatus 140 that the display unit 143 is provided with two LCDs as the LCD 151. Consequently, the fourth proposal is never practically different in structure from the second proposal shown in FIGS. 3 and 4 that has the first and the second display 123 and 128 on the first case 121. Therefore, the total thickness of the main body 142 and the display unit 143 superposed on each other and, furthermore, the information processing apparatus 140 is increased in cost.

Now, a preferred embodiment of this invention will be described with reference drawings.

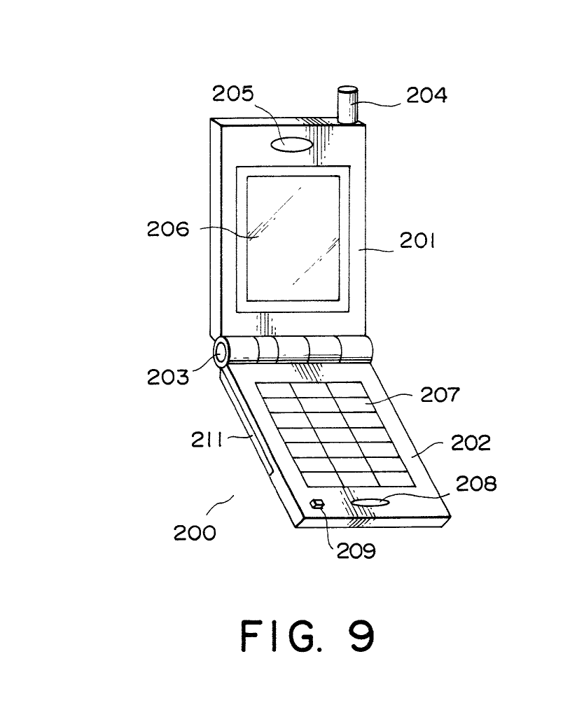

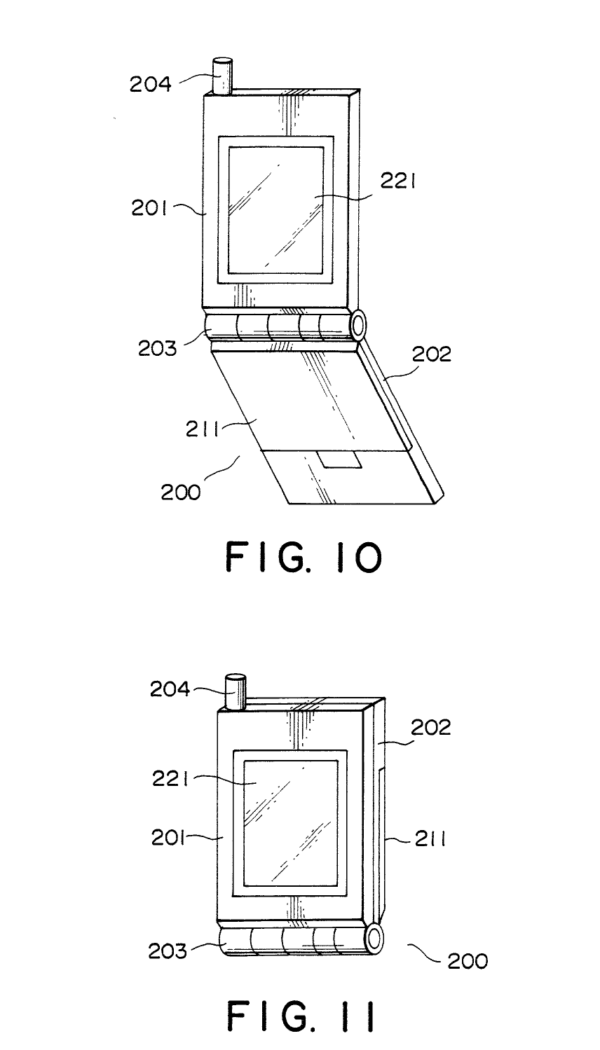

Referring to FIG. 9, a portable cellular phone 200 as an information processing apparatus according to an embodiment of this invention is unfolded. Namely, first and second cases 201 and 202 are opened from each other. The first and the second cases 201 and 202 can rotate through a hinge mechanism 203. At an upper side edge of the first case 201, an antenna 204 capable of expanding and contracting is arranged. Furthermore, on a front side surface as shown in FIG. 9, a speaker 205 for telephone talking and a front display 206 are arranged. At the front display 206, displayed content, that is, content to be displayed by the information apparatus 200 is displayed. For example, the displayed content is such as “the residual power of a battery”, “whether the apparatus is within the communicable area or not”, “date”, “time”, “condition of each part of the apparatus”, “the receipt”, and “menu of functions of the apparatus”. On a front side surface of the second case 202 facing over the front side surface of the first case 201, a keyboard 207 having a plurality of switch buttons for operation and a microphone 208 are arranged as shown in FIG. 9. Beside the microphone 208, a sensing switch 209 for sensing that the first and the second cases 201 and 202 are closed to or opened from each other. A battery unit 211 for power supply is removably contained or attached in the second case 202.

Referring to FIG. 10, the information apparatus 200 is viewed from the back side surfaces of the first and the second cases 201 and 202. On the back side surface of the first case 201, a back display 221 is arranged. The back display 221 corresponds to the front display 206 shown in FIG. 9 in location. Consequently, even if the first and the second case 201 and 202 are closed to each other, the user of the information apparatus 200 can view the displayed content by the back display 221. On the second case 202, the battery unit 211 is removably attached.

Referring to FIG. 11, the information apparatus 200 folded is viewed from the back side surface of the first case 201. Namely, the first and the second cases 201 and 202 are closed to each other. Even if the user of the information apparatus 200 faces to the back display 221, the user can view the displayed content by the back display 221 without unfolding the information apparatus 200. On the contrary, in the first proposal as shown in FIGS. 1 and 2, a user of the information apparatus 100 cannot view the displayed content by the display when the first and the second case 101 and 102 are closed to each other.

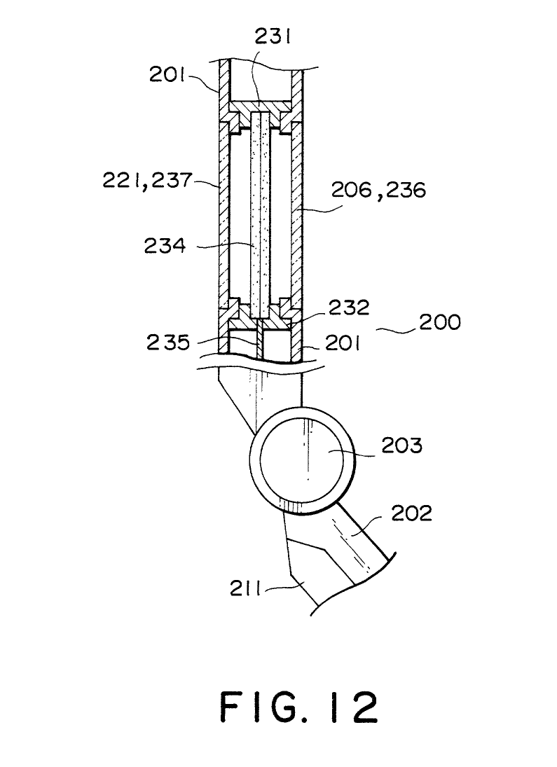

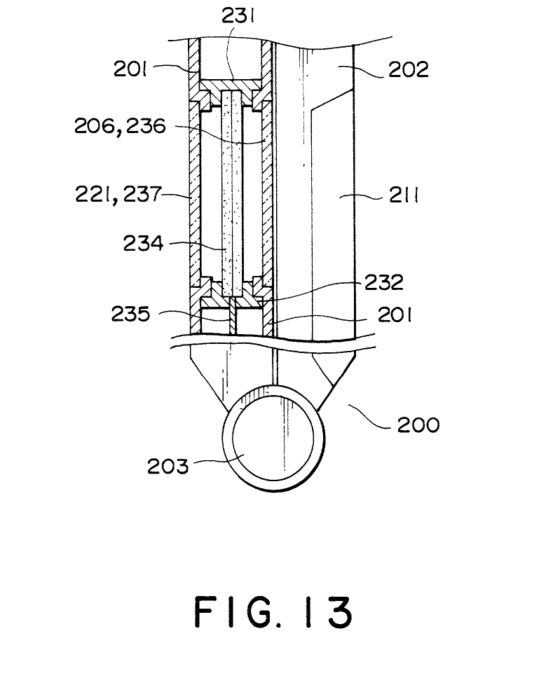

In FIG. 12, the first and the second cases 201 and 202 are opened from each other. Only a display unit (including the front and the back displays 206 and 221) is cross-sectionally shown. Within the second case 201, supporting frames 231 and 232 are arranged. Inside of each of the supporting frames 231 and 232, a dent portion is formed. An LCD 234 is held between the dent portions of the supporting frames 231 and 232. In the first case, an LCD driving circuit (not shown) for electrically driving the LCD 234. The LCD driving circuit and the LCD 234 are electrically connected to each other through a flexible wiring cable 235. Consequently, the LCD 234 is driven by driving signal from the driving circuit and displays the displayed content. Over the LCD 234 in the second case 201, front and back screens 236 and 237 are arranged with space left, respectively. The LCD 234 and the front screen 236 structure the front display 221 while the LCD 234 and the back screen 237 structure the back display 221. The front and the back screens 236 and 237 have a plate shape and are made of such as transparent or half-transparent plastics, respectively. The front and the back screens 236 and 237 protect the LCD 234 against pressure and dust from the outside of the portable cellular phone 200.

Although not shown in FIG. 12, the portable cellular phone 200 may be provided with a backlight. The backlight irradiates at least one of a space between the back screen 237 and the LCD 234 while a space between the front screen 236 and the LCD 234. Consequently, even if there is the portable cellular phone 200 in dark place, the displayed content is well viewed. On the other hand, the light from sunlight and/or room-lighting can penetrate the LCD 234 through the back screen 237. Thus, the displayed content is also sufficiently viewed through the front screen 236 by sunlight and/or room-lighting when there is the portable cellular phone 200 in well-lighted place, without the use of the backlight.

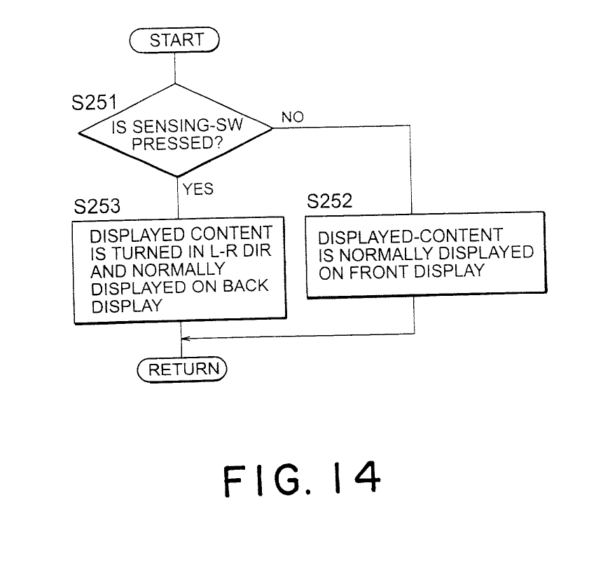

In FIG. 13, the first and the second cases 201 and 202 are closed to each other. As similar to FIG. 12, only the display unit (including the front and the back displays 206 and 221) is cross-sectionally shown in FIG. 13. The front display 206 is covered with the second case 202, so the front display 206 cannot be viewed. However, the back display 221 can be viewed and therefore the user can view the displayed content. As timing when the backlight is lighted, for example, timing when the portable cellular phone 200 receives the receipt and so on is used. The timing is similar to the conventional technique. Thus, when the portable cellular phone 200 is folded as shown in FIG. 13 and further detects information alteration such the receipt, the portable cellular phone 200 light the backlight so as to display (alert) the information alteration for the user. This is useful for saving energy because the backlight is not lighted except detecting the information alteration. However, the portable cellular phone 200 may be provided with a switch for manually lighting the backlight by the user when the portable cellular phone 200 is folded.

FIG. 14 is a flow chart for illustrating control steps for the displayed content of the front and back displays 206 and 221 shown in such as FIG. 12 by the portable cellular phone 200.

Although not shown, the portable cellular phone 200 comprises a CPU (Central Processing Unit) therein. The CPU performs various controls as a portable cellular phone by the use of control programs memorized in a ROM (Read Only Memory, which is also not shown). Furthermore, the CPU also performs displaying controls for controlling the displayed contents displayed on the front and back displays 206 and 221. Control steps of the displaying controls will be described below with referring to FIG. 14 and so on.

The CPU detects which the sensing switch 209 shown in FIG. 1 is pushed or not (Step S251). When the sensing switch 209 is not pushed by the first case 201 (Step S251: N) as the first and the second cases 201 and 202 are opened from each other as shown in FIG. 9, the CPU performs by the use of the conventional displaying control step the displaying control so that the displayed content is normally seen in the left and the light direction on the front display 206 (Step S252).

Herein, “the displayed content is normally seen” means a state that text (letter and character) and graphic, and so on as the displayed content are displayed according to the original direction (the original light and the original right sides are displayed, as its stand, as the light and the right sides) and therefore can be read, known, or deciphered by the user. In this state, if the user views the back display 221 as shown in FIG. 10, the displayed content is abnormally seen so that the original light and the original right sides are displayed as the right and the light sides. Furthermore, in the state, the displayed content displayed on the back display 221 may be turned in upward and downward directions as depending on the circumstance.

When the first and the second cases 201 and 202 are closed to each other as shown in FIG. 11, the sensing switch 209 (shown in FIG. 9) is pushed by the first case 201 (Step S251: Y). In this state, the CPU performs the displaying control so that the displayed content is normally seen in the left and the light direction on the front display 221 after expanding displaying data in a RAM (Random Access Memory, which is provided within the first case 201 but not shown) (Step S253).

In the state, the CPU processes the displaying data so that the displayed content are identically viewed in form as the same as the displayed content displayed on the front display 206 when the first and the second cases 201 and 202 are opened from each other or that only the displayed content as regards the text is turned in left and right directions.

In the former, it is necessary for the CPU to even turn in left and right directions the graphic as the displayed content, so the displaying control may be very burdened for turning the graphic, except graphic data previously turned in left and right direction can received by the portable cellular phone 200 from an upper station not shown. Therefore, it is preferred for this matter of the latter turning the text only.

In the latter, if the text as the displayed content is “written from left to right” in form, letters originally arranged at rightward side is changed into at leftward side and each letter pattern is expanded in the RAM after turning in left and right directions by itself. As depending on the kind of the information processing apparatus this process may be easily performed by only changing address referred for the displaying control.

While this invention has thus far been described in conjunction with an embodiment thereof, it will readily be possible for those skilled in the art to put this invention into practice in various other manners. For example, the information processing apparatus is never limited to the portable cellular phone, so another apparatus such as a computer of lap or palm-topped type or the like. Furthermore, although the sensing switch 209 is separately provided on the second case 202 in the embodiment, such sensing switch may be provided with another button previously provided in the portable cellular phone 200 in common-duty. In stead of the sensing switch 209, if the portable cellular phone 200 is not operated at all for the predetermined time, the CPU can virtually regard as the first and the second cases 201 and 202 are closed to each other and can change displaying state or mode.

What is claimed is:

1. An information processing apparatus comprising a hinge mechanism and first and second cases each of which has front and back sides, said first and said second cases coupled to each other through said hinge mechanism so that said information processing apparatus is folded with the front sides of said first and said second cases are faced to each other;
wherein said first case has a display unit so that a displayed content of said display unit can be seen from both of the front and the back sides of said first case;
said display unit being provided with a liquid crystal display plate having first and second sides and a pair of screens, said screens being substantially transparent and being arranged over the first and the second sides of said liquid crystal display plate;
said second case having at least one of operating buttons for the operation of said information processing apparatus.

2. An information processing apparatus as claimed in claim 1, wherein said second case is provided with a battery.

3. An information processing apparatus as claimed in claim 1, wherein said first case is provided with a speaker for telephone talking;
said second case being provided with a microphone for telephone talking.

4. An information processing apparatus as claimed in claim 1, wherein said information processing apparatus further comprises a control circuit for switching the displayed content of said display unit so that the displayed content is normally seen from any one of the front and the back sides of said first case.

5. An information processing apparatus as claimed in claim 4, wherein said control circuit switches the displayed content, when said at least one of said operating buttons is not touched for a predetermined time, so that the displayed content is normally seen in left and right directions from said back side of said first case.

6. An information processing apparatus as claimed in claim 4, wherein said first or said second case is provided with a sensing switch for sensing said first and second cases are opened from or closed to each other;
said control circuit switching the displayed content, when said sensing switch senses that said first and second cases are opened from each other, so that the displayed content is normally seen in left and right directions from said front side of said first case.
